(19) United States
(12) Patent Application Publication
(10) Pub. No.: US 2010/0231518 A1
(43) Pub. Date: Sep. 16, 2010

(54) Keyboard having multi-axis balance touch keys

(76) Inventor: Stephen Chen, Shengang Shiang (TW)

Correspondence Address: Guice Patents PLLC, 12647 Galveston Court #302, Manassas, VA, 20112, US

(21) Appl. No.: 12/149,269

(22) Filed: Apr. 29, 2008

(51) Int. Cl. G06F 3/02

(52) U.S. Cl. 345/168

(57) ABSTRACT

A keyboard having multi-axis balance touch keys and particularly a keyboard equipped with touch keys aims to provide steady depressing operation. Each touch key includes a depressible plate, a contact switch, a base and a plurality of balance elements. The balance elements are arranged in two different axial directions and latched respectively on first retaining elements located on the depressible plate and second retaining elements located on the base. The first and second retaining elements have respectively at least one horizontal slot to allow the balance elements to slide therein parallel with the depressible plate. Thus downward depressing forces can be evenly distributed and a steady depressing movement is achieved wherever the touch keys is depressed. Swaying of the touch keys can be prevented and correct output signals can be delivered from the keyboard.

### BACKGROUND OF THE INVENTION

1. Field of the Invention

The present invention relates to a keyboard having multi-axis balance touch keys and particularly to a keyboard equipped with steadier depressible touch keys to provide steady depressing wherever the touch keys is depressed and prevent swaying during depressing to deliver correct output signals.

2. Description of the Prior Art

Advance of computer technology has greatly expanded computer applications in people's life. Many novel input means have been developed (such as voice input, handwriting input recognition and the like). Among them computer keyboard best meets user's requirement and is most widely adopted. A keyboard consists of a plurality of depressible keys. Each key has a key cap with a key strut located in the center of the bottom thereof to depress a conductive rubber to connect a film circuit to transmit a signal. When in use the key is depressed quickly by users. It could happen that only the edge or a corner of the key cap is depressed, and result in unsmooth depressing of the key strut and failure of connection to the circuit that causes erroneous input operation. To remedy the aforesaid problem many schemes have been proposed. For instance, Taiwan patent No. 85205282 (called cited reference hereinafter) provides a technique to connect four corners of the key cap in a cross fashion to overcome the drawbacks mentioned above.

While the cited reference can avoid improper depressing of the key cap during operation, its structure is complex. Production is difficult and costly. The key consists of numerous elements. As a result, production yield is lower.

In recent years touch pads are very popular, and are increasingly adopted to key structure. They are easier to use and the provided function expands constantly. Use area of the touch pad on the key also increases. However, the operation elements beneath the touch pad do not match correspondingly. As a result, different areas of the touch pad respond differently when subject to a depressing force. Uneven depressing takes place. This problem is more serious as the touch pad becomes larger. Swaying often occurs when the touch pad is depressed. There are still rooms for improvement.

### SUMMARY OF THE INVENTION

As the problem of the aforesaid conventional technique is mainly caused by uneven distribution of depressing force applying to the operation elements beneath the touch pad, the present invention aims to provide a keyboard having multi-axis balance touch keys to overcome the conventional problem mentioned above. The keyboard according to the invention includes at least one touch key. The touch key includes a depressible plate which has a touch pad, a contact switch, a base and a plurality of balance elements. The balance elements are located between the depressible plate and the base to evenly distribute the total weight of the touch key.

There is a plurality of first retaining elements located at the bottom side of the depressible plate that are arranged in two different axial directions. Each axial direction has at least one first retaining element located thereon.

The contact switch pushes the bottom side of the depressible surface in regular conditions.

The base has a plurality of second retaining elements arranged in the two different axial directions. Each axial direction has at least one second retaining element located thereon.

The balance elements are located on the two different axial directions. Each balance element is formed in a [symbol] -shape with a longitudinal rod at a upper end and jutting ends at distal ends to be latched respectively to the first retaining elements and the second retaining elements. The first and second retaining elements have at least one horizontal slot to allow the balance element to slide therein in parallel with the depressible plate thereby to evenly distribute the downward pressing force. Thus wherever the touch key is depressed a steady and vertical up and down movement can be formed to fully trigger the contact switch to achieve a steady depressing operation without swaying. Therefore a correct output signal can be generated.

The invention, by deploying multiple balance elements in multiple axial directions, allows the touch pad to be divided into multiple depressing segments. Any depressing segment can be touched by users and the entire depressible plate can get an even support and downward force to form a steady and vertical up and down movement. Thus it effectively solves the conventional problem. It also can prevent swaying for a larger size touch pad during depressing operation.

In one aspect different depressing segments of the touch pad can be made to output different signals to represent varying characters or symbols defined by the system of an electronic device (such as a computer). Namely when one depressing segment is depressed the contact switch is triggered to output a different corresponding signal.

In another aspect the balance elements are arranged in the two axial directions and cross each other orthogonally. At the crossing spot at least one of two balance elements has at least one concave portion to allow each balance element to be moved on a same planar surface without interfering with each other.

In yet another aspect the balance elements are arranged in the two axial directions and laid in a L-shape.

In yet another aspect the balance elements are arranged in the two axial directions and laid in a #-shape.

In yet another aspect the balance elements are arranged in the two axial directions and laid in a H-shape.

In yet another aspect at least one of the first retaining elements at the bottom side of the depressible plate has a positioning latch trough formed with an indented retaining portion to be wedged in by the longitudinal rod of the balance element without escaping and allow the longitudinal rod to turn therein.

In yet another aspect at least one of the first retaining elements at the bottom side of the depressible plate has a sliding latch slot formed with a horizontal slot to be wedged in and slidable by the jutting end of the balance elements.

In yet another aspect at least one of the second retaining elements on the base has a positioning latch trough formed with an indented retaining portion to be wedged in by the longitudinal rod of the balance rod without escaping and allow the longitudinal rod to turn therein.

In yet another aspect at least one of the second retaining elements on the base has a sliding latch slot formed with a horizontal slot to be wedged in and slidable by the jutting end of the balance elements.

In yet another aspect at least two of the balance elements are cross with each other and arranged in the different axial directions. One of the balance elements has the longitudinal rod latched to the second retaining element on the base and the jutting end latched to the first retaining element beneath the depressing plate, and another balance element has the longitudinal rod latched to the first retaining element beneath the depressing plate and the jutting end latched to the second retaining element on the base to prevent interfering with each other during movement.

In yet another aspect the balance elements are made of a metal bar (such as a steel wire) to enhance the rigidness of the balance elements.

The foregoing, as well as additional objects, features and advantages of the invention will be more readily apparent from the following detailed description, which proceeds with reference to the accompanying drawings. The embodiments discussed below serve merely for illustrative purpose and are not the limitation of the invention.

### BRIEF DESCRIPTION OF THE DRAWINGS

FIG. 1 is a plane view of the keyboard of the invention.

FIG. 2 is an exploded view of the invention.

FIG. 3 is a sectional view of the invention in an operating condition.

FIG. 4 is a sectional view of the invention in another operating condition.

FIG. 5 is an exploded view of a second embodiment of the invention.

FIG. 6 is a sectional view of the second embodiment of the invention in an operating condition.

FIG. 7 is a sectional view of the second embodiment of the invention in another operating condition.

FIG. 8 is an exploded view of a third embodiment of the invention.

FIG. 9 is a sectional view of the third embodiment of the invention in an operating condition.

FIG. 10 is a sectional view of the third embodiment of the invention in another operating condition.

FIG. 11 is an exploded view of a fourth embodiment of the invention.

FIG. 12 is a sectional view of the fourth embodiment of the invention in an operating condition.

FIG. 13 is a sectional view of the fourth embodiment of the invention in another operating condition.

FIG. 14 is an exploded view of a fifth embodiment of the invention.

FIG. 15 is a sectional view of the fifth embodiment of the invention in an operating condition.

FIG. 16 is a sectional view of the fifth embodiment of the invention in another operating condition.

FIG. 17 is an exploded view of a sixth embodiment of the invention.

FIG. 18 is a sectional view of the sixth embodiment of the invention in an operating condition.

FIG. 19 is a sectional view of the sixth embodiment of the invention in another operating condition.

FIG. 20 is an exploded view of a seventh embodiment of the invention.

FIG. 21 is a sectional view of the seventh embodiment of the invention in an operating condition.

FIG. 22 is a sectional view of the seventh embodiment of the invention in another operating condition.

### DESCRIPTION OF THE PREFERRED EMBODIMENTS

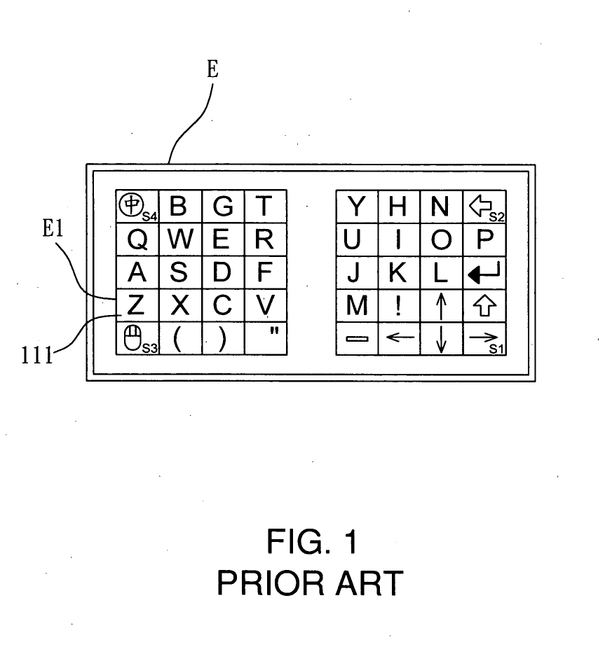

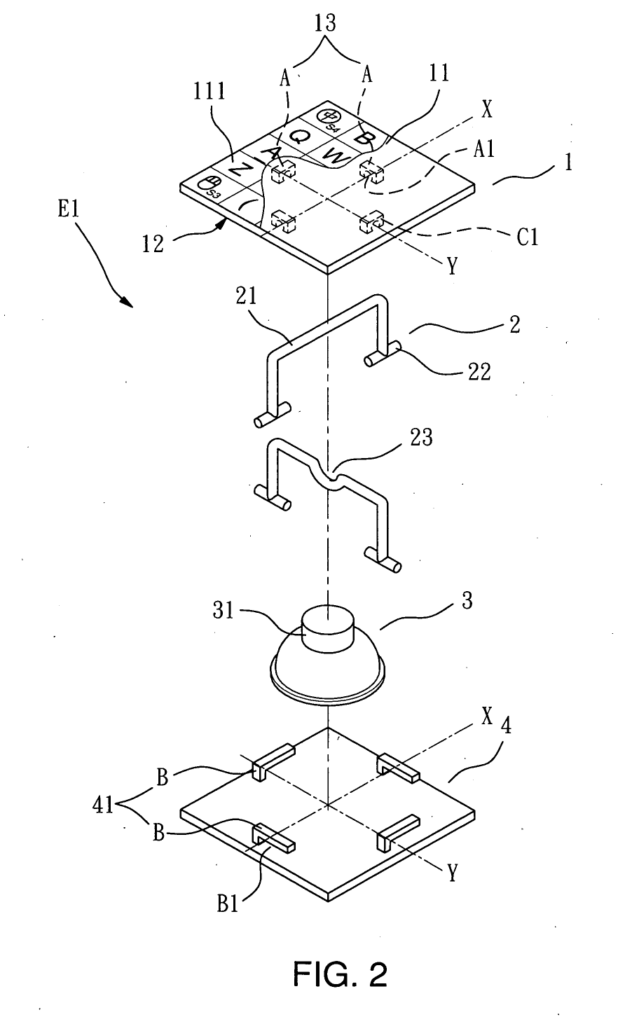

Please referring to FIGS. 1 through 4, the invention provides a keyboard E which has at least one touch key E1. The touch key E1 includes at least one depressible plate 1 which has a touch pad 11, a contact switch 3, a base 4 and a plurality of balance elements 2. The balance elements 2 are located between the depressible plate 1 and the base 4.

The touch pad 11 is divided into multiple depressing segments 111. There are a plurality of first retaining elements 13 located at a bottom side 12 of the depressible plate 1 that are arranged in two different axial directions X and Y. Each of the axial directions X and Y has at least one first retaining element 13 located thereon. Each depressing segment 111 aims to control a different output signal to execute a character defined by the system of an electronic device (such as a computer). For instance, in FIG. 1, each depressing segment 111 represents a different character. Thus when a different depressing segment 111 of the touch pad 11 is depressed the contact switch 3 is triggered to output a different signal.

The contact switch 3 is elastic and has an elastic depressing space 30 and a top portion 31 pushing the bottom side 12 of the depressible plate 1 in regular conditions to hold it upward. The contact switch 3 is a pushbutton switch.

The base 4 has a plurality of second retaining elements 41, located thereon arranged in the two different axial directions X and Y. Each of the axial directions X and Y has at least one second retaining element 41 located thereon.

The balance elements 2 are located on the two different axial directions X and Y. Each of the balance elements 2 is formed in a [symbol] -shape, and has a longitudinal rod 21 at a upper end and jutting ends 22 at distal ends to be latched respectively to the first retaining elements 13 and the second retaining elements 41. The first and second retaining elements 13 and 41 have at least one horizontal slot B1 to allow the balance element 2 to slide therein in parallel with the depressible plate 1.

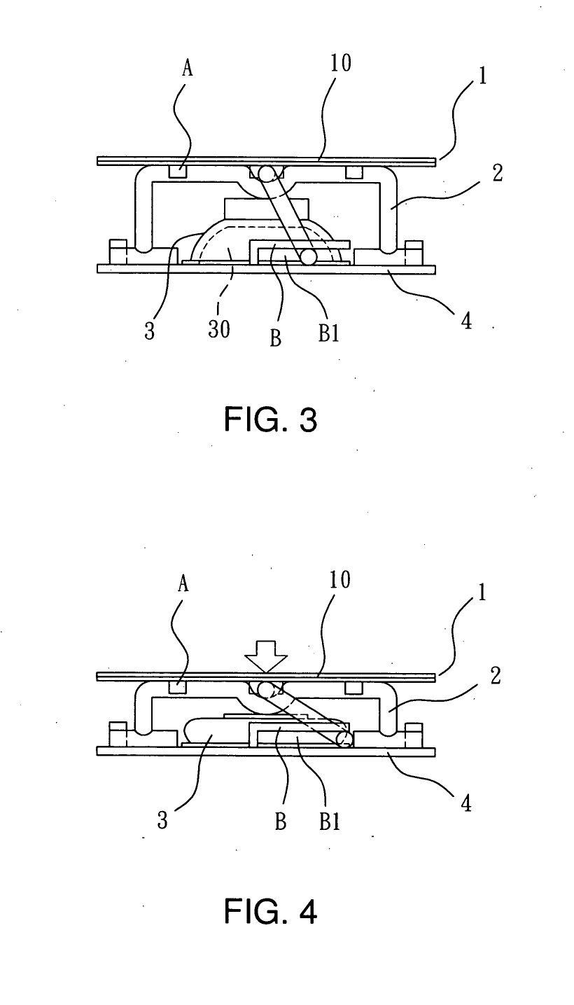

By means of the elements and construction set forth above, the longitudinal rod 21 of the balance elements 2 is latched on the first retaining element 13 at the bottom side 12 of the depressible plate 1 and the jutting ends 22 are latched on the second retaining element 41 on the base 4, and are positioned in the two axial directions X and Y. Upon receiving a depressing force from a user's finger (referring to FIG. 4), the depressible plate 1 is moved downwards to push the contact switch 3 and the balance elements 2. The balance elements 2 are tilted. The second retaining element 41 has a sliding latch slot B formed with the horizontal slot B1 to allow the jutting end 22 to slide inside. Moreover, as multiple balance elements 2 are positioned in the two axial directions X and Y, the depressing force exerting onto the depressible plate 1 is evenly distributed. Thus wherever the depressible plate 1 is depressed a steady and vertical up and down movement can be formed to trigger the contact switch 3 without swaying, and a correct output signal can be generated through the keyboard E. When the depressing force is released, the contact switch 3 no longer receives the external force, thus returns to its original shape due to its elasticity. The top portion 31 pushes the depressible plate 1 upwards as in the regular conditions (referring to FIG. 3).

The balance elements 2 are arranged in the axial directions X and Y cross with each other in an orthogonal fashion. At the crossing spot at least one of the balance elements 2 has at least one concave portion 23 to allow each balance element 2 to be moved at the same planar surface without interfering with each other (referring to FIGS. 1 through 4).

Among the first retaining elements 13 located at the bottom side 12 of the depressible plate 1, at least one of them has a positioning latch trough A formed with an indented retaining portion A1 to latch the longitudinal rod 21 of the balance element 2 and allow the longitudinal rod 21 to turn therein.

Among the second retaining elements 41 located on the base 4, at least one of them has one sliding latch slot B formed with one horizontal slot B1 to latch the jutting end 22 and allow the jutting end 22 to slide therein.

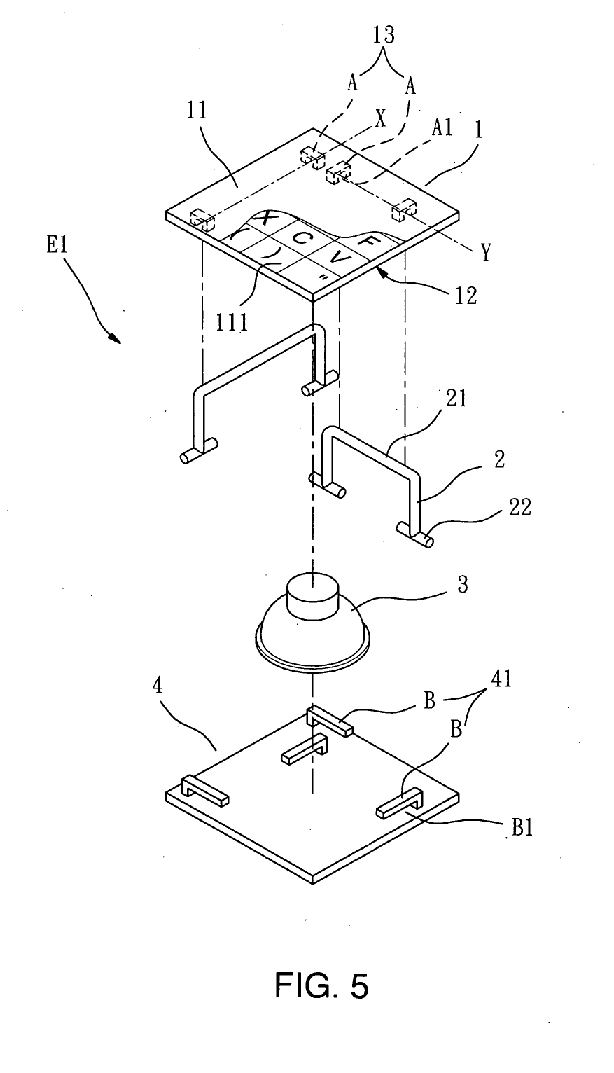

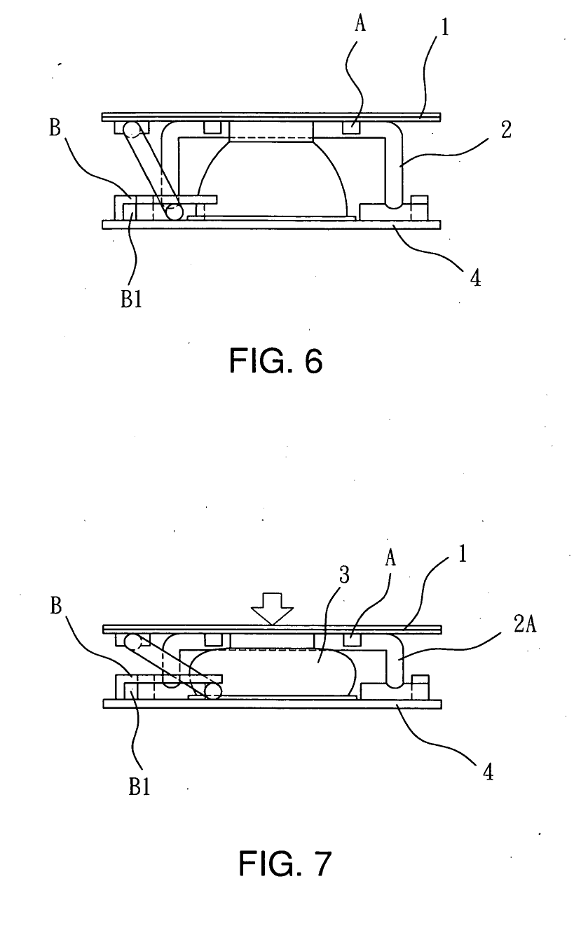

Refer to FIG. 5 for a second embodiment of the invention. In this embodiment a plurality of first retaining elements 13 are provided at the bottom side 12 of the depressible plate 1 and arranged in two different axial directions X and Y in a L-shape each having a positioning latch trough A to latch the longitudinal rod 21 of the balance elements 2. The contact switch 3 pushes the bottom side 12 of the depressible plate 1 in the regular conditions. The jutting ends 22 at two sides of each balance element 2 are latched in the sliding latch slot B of the second retaining element 41 and slidable to and fro in the horizontal slot B1 when depressed (referring to FIGS. 6 and 7). The operation is same as the previous embodiment. Thus the balance elements 2 can slide along the two axial directions to evenly distribute the depressing force to allow the depressible plate 1 to be moved steadily and vertically up and down to trigger the contact switch 3.

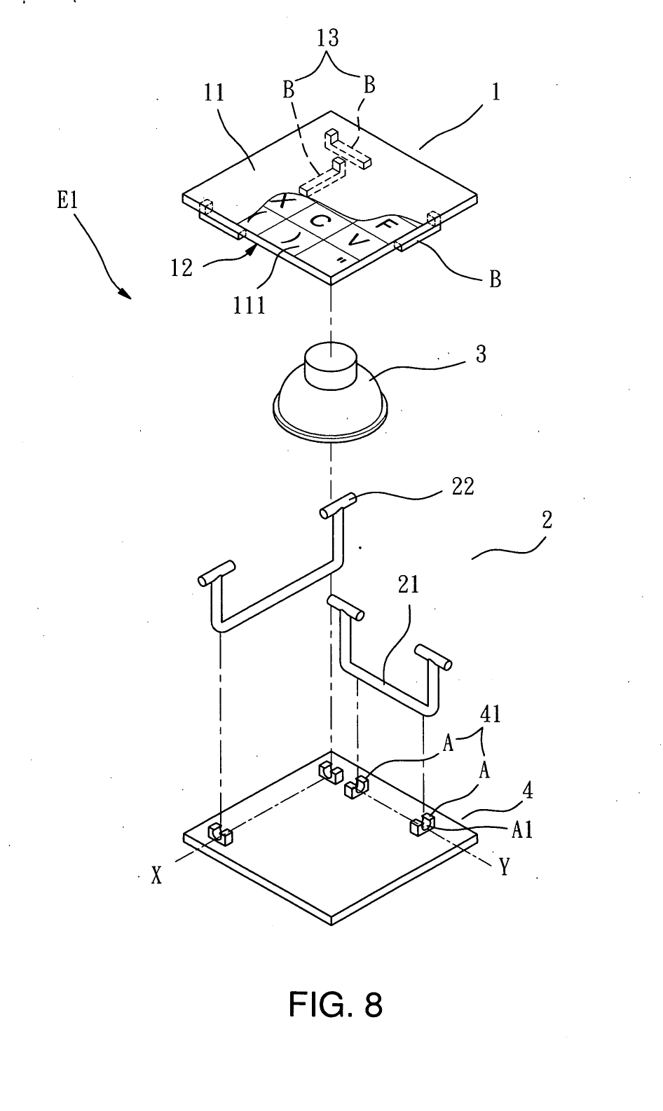

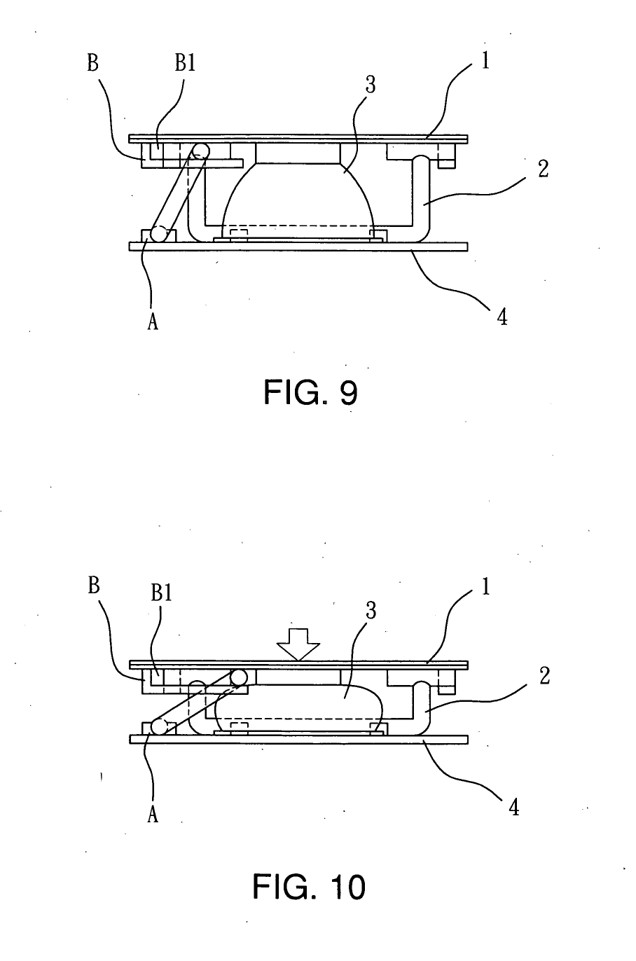

Refer to FIGS. 8, 9 and 10 for a third embodiment of the invention. In this embodiment the first retaining elements 13 at the bottom side 12 of the depressible plate 1 have sliding latch slots B each having one horizontal slot B1 to latch the jutting end 22 of at least one balance element 2 and allow the jutting end to slide therein. Each of the second retaining elements 41 located on the base 4 has one positioning latch trough A formed with one indented retaining portion A1 to latch the longitudinal rod 21 of the balance element 2 and allow the longitudinal rod to turn therein. Therefore the total weight of the touch key E1 can be evenly distributed. Moreover, the first retaining elements 13 and second retaining elements 41 are arranged in the two different axial directions X and Y corresponding to the balance elements 2 which cross each other in a L-shape. The balance elements 2 are depressible and slidable to and fro in a manner same as the embodiments previously discussed. Thus by providing multiple balance elements 2 slidable in the two axial directions the depressing force can be evenly distributed to allow the depressible plate 1 to be moved steadily and vertically up and down to trigger the contact switch 3.

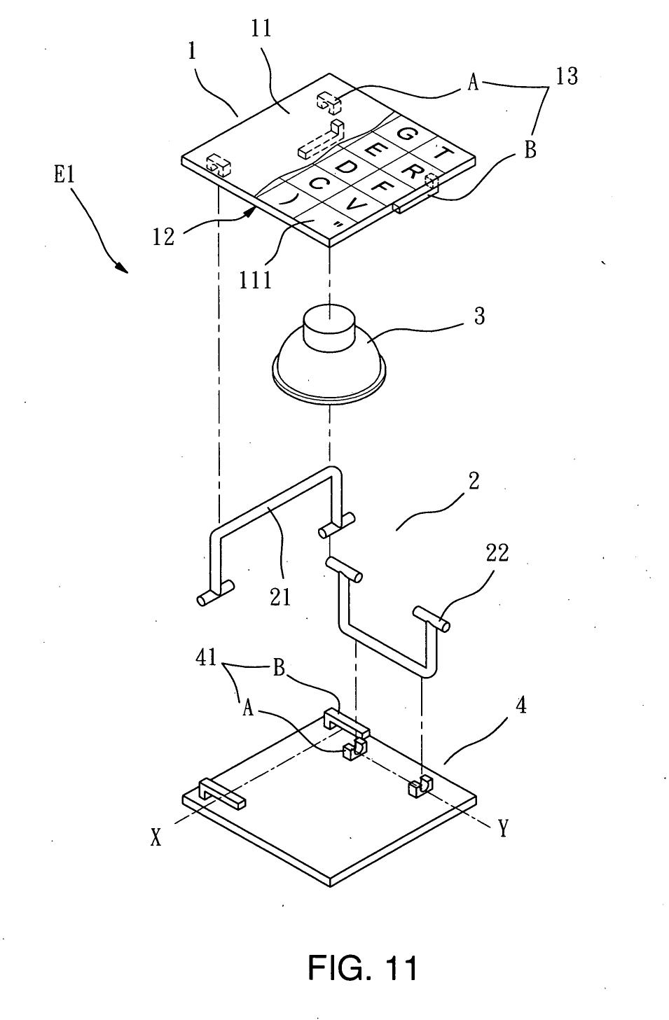

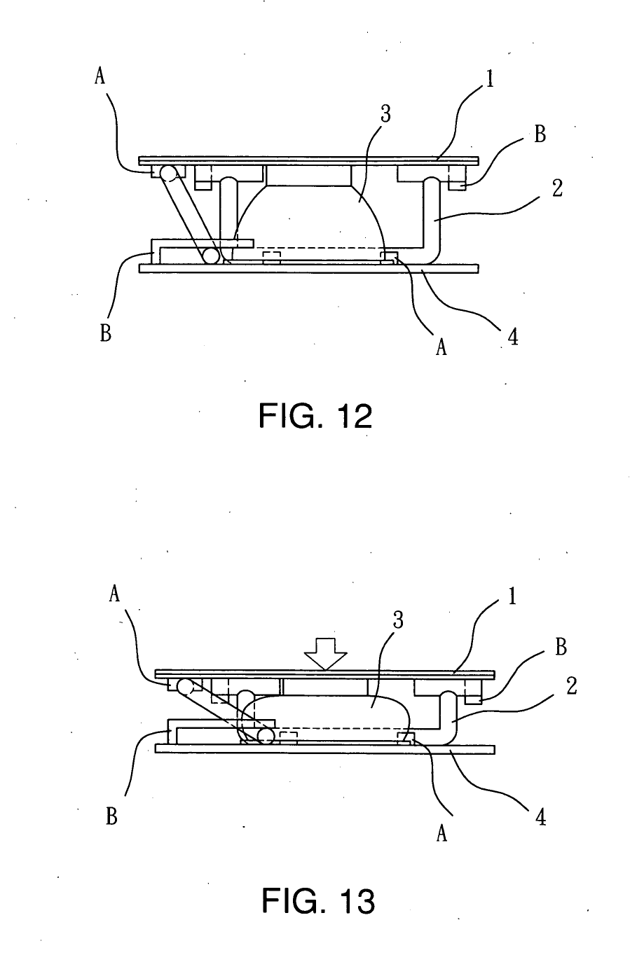

Refer to FIGS. 10, 11 and 12 for a fourth embodiment of the invention. In this embodiment the first retaining elements 13 at the bottom side 12 of the depressible plate 1 have at least one positioning latch trough A and at least one sliding latch slot B. The base 4 has a plurality of second retaining elements 41 which have at least one positioning latch trough A and at least one sliding latch slot B that are arranged in two the different axial directions X and Y. The balance element 2 are arranged in a L-shape and latched on the first and second retaining elements 13 and 41. Operation is same as previous embodiments. Thus the balance elements 2 can slide along the two axial directions to evenly distribute the depressing force to allow the depressible plate 1 to be moved steadily and vertically up and down to trigger the contact switch 3.

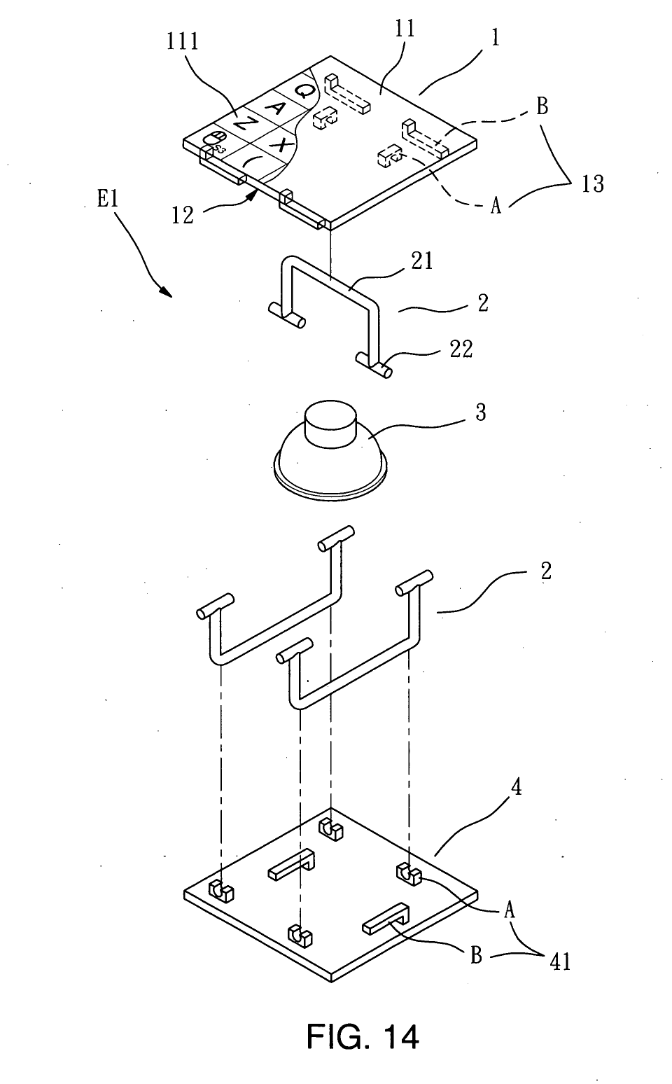

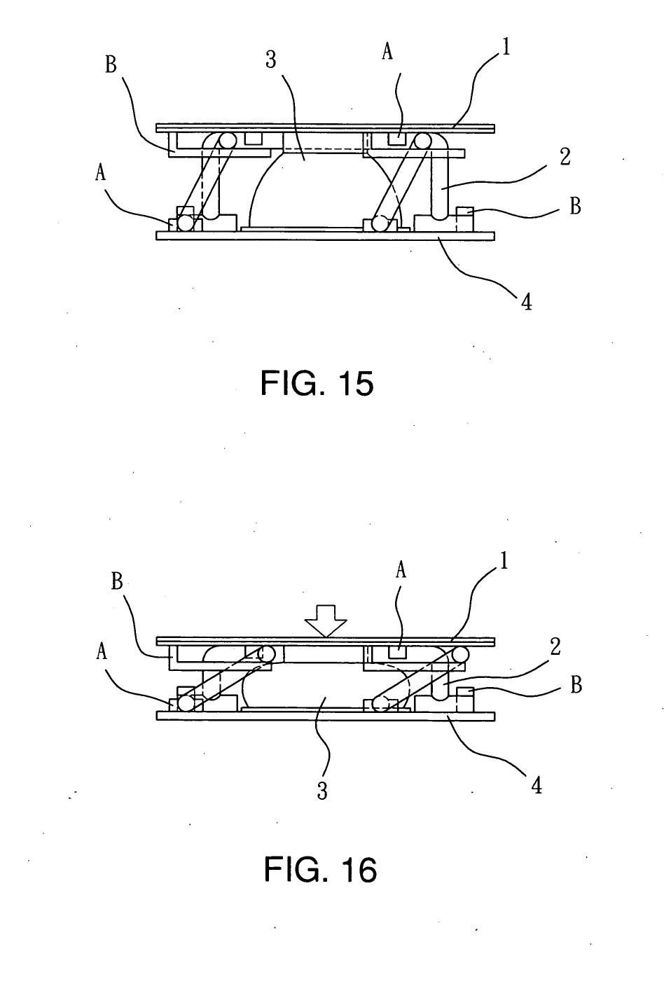

Refer to FIGS. 14, 15 and 16 for a fifth embodiment of the invention. In this embodiment there are a plurality of first retaining elements 13 at the bottom side 12 of the depressible plate 1 that have at least one positioning latch trough A and at least one sliding latch slot B. The base 4 has a plurality of second retaining elements 41 corresponding to the first retaining elements 13 that have at least one positioning latch trough A and at least one sliding latch slot B that are arranged in the two different axial directions X and Y. There are three balance elements 2 arranged in a H-shape corresponding to the first and second retaining elements. Operation is same as previous embodiments. Thus the balance elements 2 can slide along the two axial directions to evenly distribute the depressing force to allow the depressible plate 1 to be moved steadily and vertically up and down to trigger the contact switch 3.

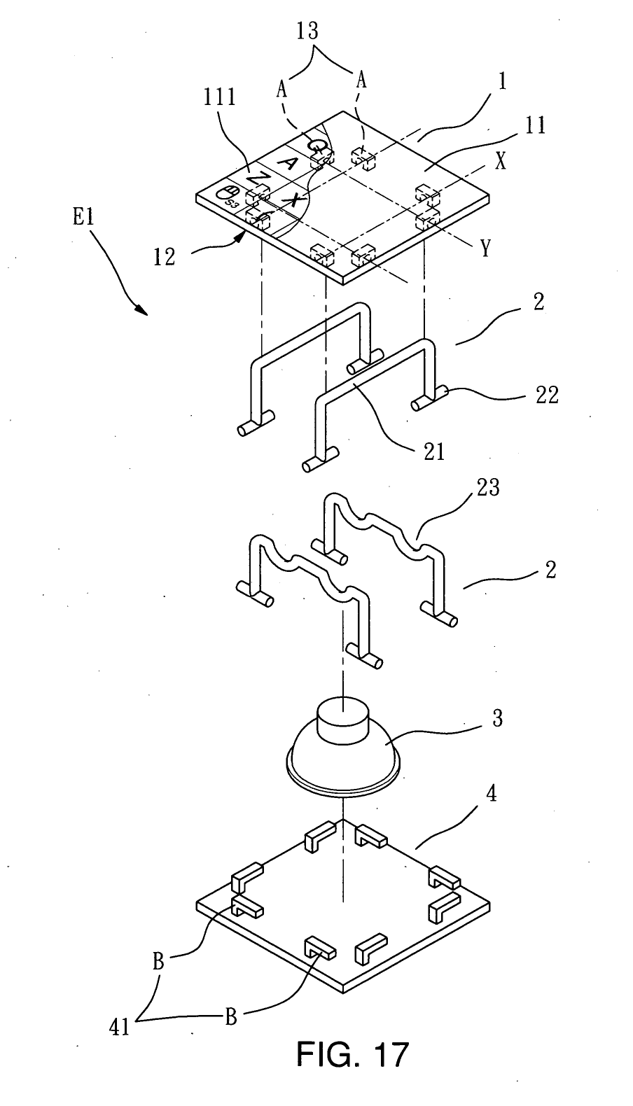

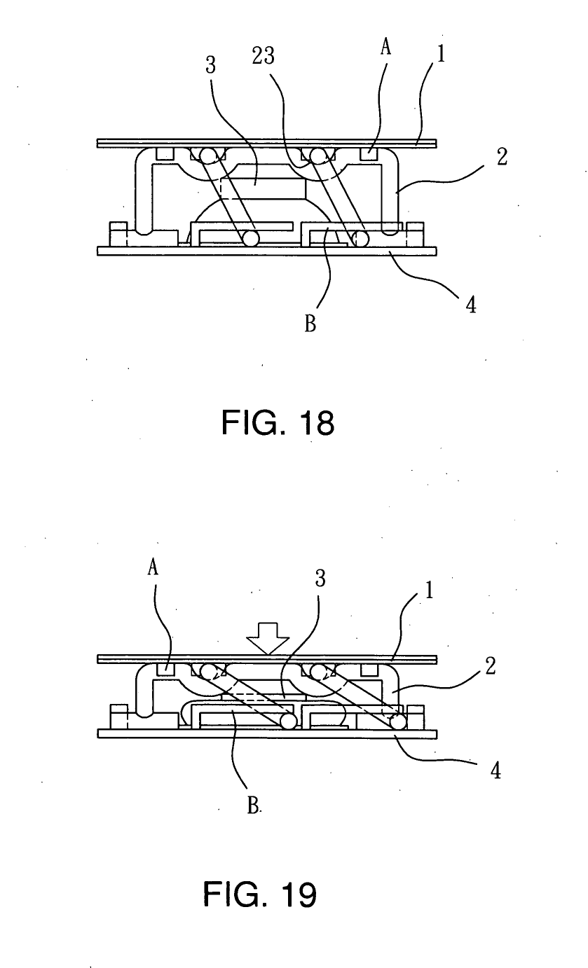

Refer to FIGS. 17, 18 and 19 for a sixth embodiment of the invention. In this embodiment there are a plurality of first retaining elements 13 at the bottom side 12 of the depressible plate 1 that have at least one positioning latch trough A. The base 4 has a plurality of second retaining elements 41 corresponding to the first retaining elements 13 that have at least one sliding latch slot B. The second retaining elements 41 are arranged in the two different axial directions X and Y. A plurality of balance elements 2 are provided and arranged in a #-shape to be latched in the retaining elements. At least one of the balance elements 2 has a plurality of concave portion 23 at the crossing spots to prevent mutual interference during movement. They also are depressible and slidable to and fro. The operation is same as the previous embodiments. Thus the balance elements 2 can slide along the two axial directions to evenly distribute the depressing force to allow the depressible plate 1 to be moved steadily and vertically up and down to trigger the contact switch 3.

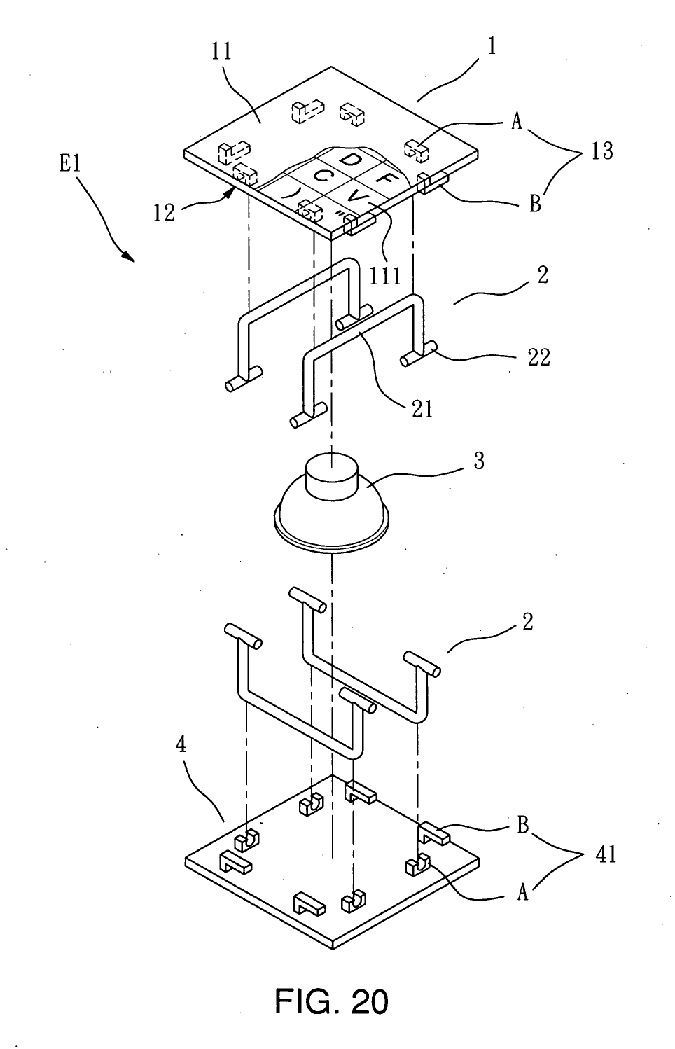

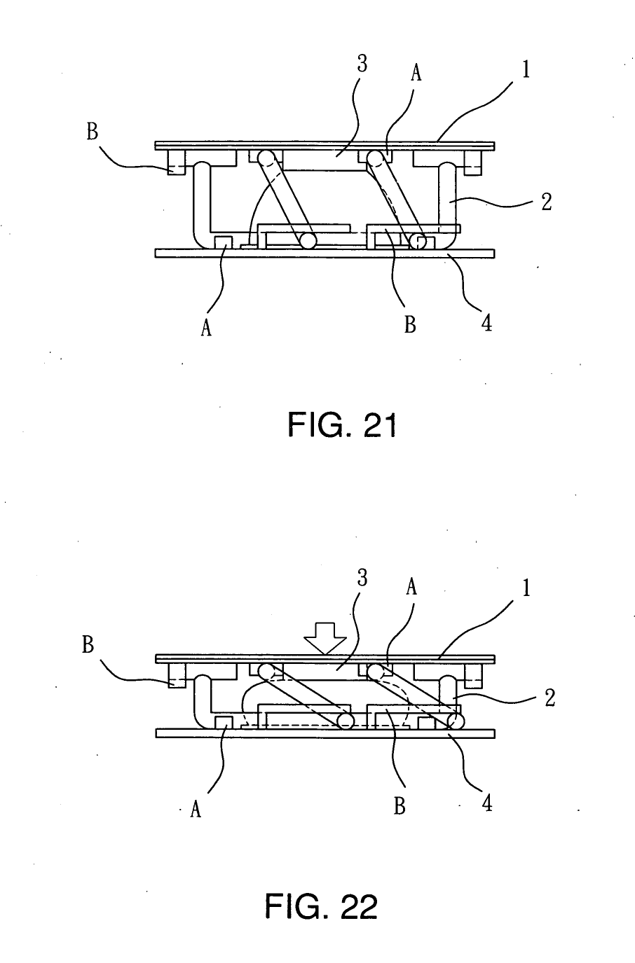

Refer to FIGS. 20, 21 and 22 for a seventh embodiment of the invention. In this embodiment there are a plurality of first retaining elements 13 at the bottom side 12 of the depressible plate 1 that have at least one positioning latch trough A and at least one sliding latch slot B. The base 4 has a plurality of second retaining elements 41 corresponding to the first retaining elements 13 that have at least one positioning latch trough A and at least one sliding latch slot B. The second retaining elements 41 are arranged in the two different axial directions X and Y. A plurality of balance elements 2 are provided and arranged in a #-shape corresponding to the first and second retaining elements for latching and movement. The operation is same as the previous embodiments. Thus the balance elements 2 can slide along the two axial directions to evenly distribute the depressing force to allow the depressible plate 1 to be moved steadily and vertically up and down to trigger the contact switch 3.

As a conclusion, the invention provides a simpler structure and can be fabricated and assembled easier. It allows the key to be moved steadily and vertically up and down to trigger the contact switch to generate different output signals. It can substitute the conventional keyboard and offer significant improvement.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A keyboard having multi-axis touch keys comprising at least one touch key which includes a depressible plate, a contact switch, a base and a plurality of balance elements, wherein:
the depressible plate is divided into a plurality of depressing segments to generate different output signals upon depressing and has a bottom side coupling with a plurality of first retaining elements which are arranged in two different axial directions, each axial direction having at least one first retaining element located thereon;
the contact switch pushes the bottom side of the depressible plate in regular conditions;
the base has a plurality of second retaining elements located thereon that are arranged in the two different axial directions, each axial direction having at least one second retaining element located thereon; and
the balance elements are distributed in the two different axial directions, each of the balance elements being formed in a [symbol] -shape and having a longitudinal rod at a upper end and jutting ends at distal ends that are latched respectively on the first retaining element and the second retaining element, the first and second retaining elements having at least one horizontal slot to allow one balance element to slide therein in parallel with the depressible plate such that the depressible plate is depressible at any location and movable steadily and vertically up and down to trigger the contact switch.

2. The keyboard of claim 1, wherein the balance elements are arranged in the two axial directions and cross each other in an orthogonal fashion.

3. The keyboard of claim 1, wherein the balance elements are arranged in the two axial directions and formed in an L-shape.

4. The keyboard of claim 1, wherein the balance elements are arranged in the two axial directions and cross each other in a #-shape.

5. The keyboard of claim 1, wherein the balance elements are arranged in the two axial directions and formed in an H-shape.

6. The keyboard of claim 1, wherein the balance elements are made of a metal bar.

7. The keyboard of claim 1, wherein the contact switch is elastic and has an elastic depressible space.

8. The keyboard of claim 1, wherein the contact switch is pushbutton switch.

9. The keyboard of claim 1, wherein each first retaining element has a positioning latch trough which has an indented retaining portion to latch the longitudinal rod and allow the longitudinal rod to turn therein.

10. The keyboard of claim 1, wherein each first retaining element has a sliding latch slot which has a horizontal slot to latch the jutting end and allow the jutting end to slide therein.

11. The keyboard of claim 1, wherein each second retaining element has a positioning latch trough which has an indented retaining portion to latch the longitudinal rod and allow the longitudinal rod to turn therein.

12. The keyboard of claim 1, wherein each second retaining element has a sliding latch slot which has a horizontal slot to latch the jutting end and allow the jutting end to slide therein.

13. The keyboard of claim 1, wherein the balance elements are located between the depressible plate and the base, at least one of the balance elements having the longitudinal rod latched on the second retaining elements of the base and the jutting ends latched on the first retaining elements beneath the depressible plate thereby to evenly distribute total weight of the touch key.

14. The keyboard of claim 1, wherein at least two of the balance elements cross each other in the two different axial directions, one of the balance elements having the longitudinal rod latched on the second retaining elements on the base and the jutting ends latched on the first retaining elements beneath the depressible plate, another balance element having the longitudinal rod thereof latched on the first retaining elements beneath the depressible plate and the jutting ends thereof latched on the second retaining elements on the base to prevent moving interference.
